(19) United States
(12) Patent Application Publication
(10) Pub. No.: US 2025/0109152 A1
(43) Pub. Date: Apr. 3, 2025

(54) PROCESS FOR PREPARING BICYCLO[2.2.2]OCTANE-1,4-DIOL

(71) Applicant: Eastman Chemical Company, Kingsport, TN (US)

(72) Inventor: Robert Jacks Sharpe, Madison, AL (US)

(73) Assignee: Eastman Chemical Company, Kingsport, TN (US)

(21) Appl. No.: 18/980,032

(22) Filed: Dec. 13, 2024

Related U.S. Application Data
(63) Continuation of application No. 17/755,474, filed on Apr. 29, 2022.

(51) Int. Cl. C07F 7/18

(52) U.S. Cl. CPC C07F 7/1804

(57) ABSTRACT

Provided is a process for preparing bicyclo[2.2.2]octane-1,4-diol starting from cyclohexane-1,4-dione. The dione is reacted with certain trialkylsilyl halides or trimethylsilyl trifluormethanesulfonate in the presence of a non-nucleophilic base to afford a silyl-substituted diene, which is in turn reacted with ethylene and subsequently reduced to provide the title compound.

### CROSS-REFERENCE TO RELATED APPLICATIONS

This application is a continuation of U.S. application Ser. No. 17/755,474 filed Apr. 29, 2022; which is a national stage filing under 35 USC § 371 of International Application Number PCT/US2019/059973 filed on Nov. 6, 2019, now expired.

### FIELD OF THE INVENTION

This invention belongs to the field of synthetic organic chemistry. In particular, it relates to a process for preparing bicyclo[2.2.2]octane-1,4-diol starting from cyclohexane-1,4-dione.

### BACKGROUND OF THE INVENTION

Bicyclo[2.2.2]octanes substituted at 1- and/or 4-positions are of great commercial interest. See, for example: (a) Joel G. Whitney, W. A. Gregory, J. C. Kauer, J. R. Roland, Jack A. Snyder, R. E. Benson and E. C. Hermann “Antiviral agents. I. Bicyclo[2.2.2]octan- and -oct-2-enamines” J. Med. Chem., 1970, 13, 254-60; (b) U.S. Pat. No. 3,546,290. (c) “4-Pyridyl and 4-(substituted-pyridyl) bicyclo[2.2.2]octane-1-amines” U.S. Pat. No. 3,367,941; and (d) Bicyclo[2.2.2] Acid GPR120 Modulators, US Pat. Appl. 2016/0039780.

Unfortunately, the bridgehead substituents of various bicyclic systems inclusive of the bicyclo[2.2.2]octane system are inert to nucleophilic substitution. Therefore, it would be useful to develop simple methods of preparation of the bridgehead bicyclo[2.2.2]octane derivatives. 1,4-Diacetoxybicyclo[2.2.2]octane is particularly interesting because it is a potential starting material for the preparation of various bridgehead bicyclo[2.2.2]octane derivatives. By way of example, U.S. Pat. No. 6,649,660 teaches various adenosine receptor antagonists, such compounds containing bridgehead bicyclo[2.2.2]octane substituents, which can be prepared from 1,4-diacetoxybicyclo[2.2.2]octane. Bicyclo[2.2.2]octane derivatives also serve as important intermediates in the synthesis of natural products such as terpenes and alkaloids. (see, for example, Org. Biomol. Chem., 2006, 4, 2304-2312). They are also important building blocks for therapeutic agents for the treatment of metabolic syndrome (see, for example, Bioorg. Med. Chem. Lett., 2005, 15, 5266-5269) and other diseases (Org. Biomol. Chem., 2006, 4, 2304-2312). Moreover, bicyclo[2.2.2]octane diols and diacids are useful as specialty monomers for certain polymers. See, for example, (a) G.B. U.S. Pat. No. 1,024,487; (b) J. Polym. Sci. Part A, 2010, Vol. 48, pp. 2162-2169; (c) U.S. Pat. No 3,256,241; (d) U.S. Pat. No. 3,081,334; (e) Mal. Cryst. Liq. Cryst., 1981, Vol. 66, pp. 267-282; (f) J. Polym. Sci. A, 1994, Vol 32, pp. 2953-2960; and (g) J. Am. Chem. Soc. 1970, Vol 92, pp. 1582-1586.

### SUMMARY OF THE INVENTION

The invention is as set forth in the appended claims. In general, the invention provides a process for preparing bicyclo[2.2.2]octane-1,4-diol starting from cyclohexane-1,4-dione. The dione is reacted with certain trialkylsilyl halides or trimethylsilyl trifluormethanesulfonate in the presence of a non-nucleophilic base to afford a silyl-substituted diene, which is in turn reacted with ethylene and subsequently reduced to provide the title compound.

### DETAILED DESCRIPTION OF THE INVENTION

In one aspect, the invention provides a process for preparing compounds of the Formula (II):

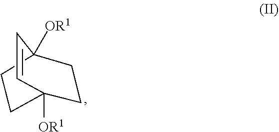

wherein R¹ is a group of the formula of the formula —Si(C₁-C₆ alkyl)₃, which comprises:
(a) contacting cyclohexane-1,4-dione with a non-nucleophilic base, in the presence of
   (i) a compound of the formula (R²)₃Si—X, wherein X is chosen from chloro, bromo, or iodo, and R² is a C₁-C₆ alkyl group, or
   (ii) trimethyl silyltrifluormethanesulfonate, followed by
(b) reaction with ethylene at a temperature of about 200° to about 300° C. and a pressure of about 3000 to 5000psi.

The compounds of Formula (II) are useful intermediates in the synthesis of bicyclo[2.2.2]octane-1,4-diol and thus provide a further aspect of the invention.

In further aspect, the invention provides a process for preparing a compound of the Formula (I), i.e., bicyclo[2.2.2]octane-1,4-diol:

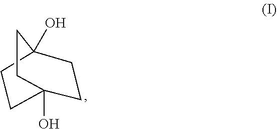

which comprises treatment of a compound of Formula (II)

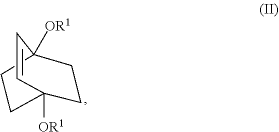

with hydrogen in the presence of a hydrogenation catalyst.

In a further aspect, the invention provides a process for preparing a compound of the Formula (I)

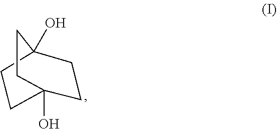

which comprises:
(a) contacting cyclohexane-1,4-dione with a non-nucleophilic base, in the presence of
   (i) a compound of the formula (R²)₃Si—X, wherein X is chosen from chloro, bromo, or iodo, and R² is a C₁-C₆ alkyl group, or
   (ii) trimethylsilyl trifluormethanesulfonate, followed by
(b) reaction with ethylene at a temperature of about 200° to about 300° C. and a pressure of about 3000 to 5000psi, to afford a compound of the Formula (II)

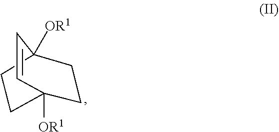

wherein R¹ is a group of the formula of the formula —Si(C₁-C₆ alkyl)₃, followed by
(c) treatment with hydrogen in the presence of a hydrogenation catalyst.

In the process of the invention, the first step involves bis-enolization of the commercially available 1,4-cyclohexanedione (CAS No. 637-88-7) with a non-nucleophilic base, in the presence of a tri (C₁-C₆ alkyl) silyl halide. In one embodiment, the first step is conducted at a temperature of about 10 to about 45° C. In certain embodiments, the process may be conducted in aprotic solvents such as toluene, methylene chloride, N,N-dimethylformamide, xylenes, dichloroethane, acetonitrile, and the like, and in the case of, for example, toluene, the process may be carried out at temperatures as high as 130° C. As used herein, the term “non-nucleophilic base” will be understood to refer to any compound sufficiently basic under the reaction conditions employed to extract a proton from the 1,4-cyclohexanedione to afford an enol type intermediate reactive species, while at the same time itself lacking a nucleophilic character so as to interfere with the desired enolization. Many examples of such bases can be used in this regard, for example 2,3,4,6,7,8,9,10-octahydropyrimido[1,2-a]azepine (also known as “DBU”), 1,5,7-Triazabicyclo[4.4.0]dec-5-ene (also known as “TBD”), and alkali metal salts of tertiary alkoxides such as potassium t-butoxide. In cases where a polar aprotic solvent is used, such as N,N-dimethylformamide (DMF), a tri(C1-C6 alkyl)amine, such as triethylamine may also be utilized.

Examples of compounds of the formula (R²)₃Si—X include trimethylsilyl chloride, trimethylsilyl bromide, triethylsilyl chloride, triethylsilyl bromide, trimethylsilyl iodide, triethylsilyl iodide, and the like.

The first step in the reaction above affords a mixture of dienes having the Formulae (A) and (B):

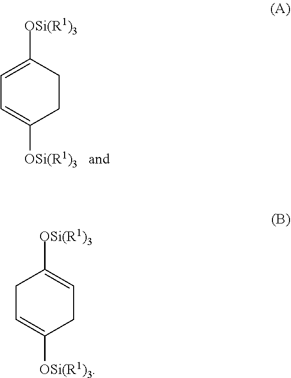

In this process, the ratio of (A) to (B) was found to be about 9:1.

Referring to the compound of Formula (A) above, reaction with ethylene at a temperature of about 200° C. to about 300° C., and a pressure of about 3000 psi to about 5000 psi afforded the intermediate compound of Formula (II):

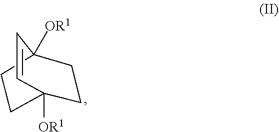

wherein R¹ is a C₁-C₆ alkyl group. The by-product (B) above is unreactive with the ethylene, so the approximate 9:1 mixture can be used as is in the addition reaction with ethylene.

Next, the compound of Formula (II) is subjected to hydrogenation conditions, i.e., hydrogen in the presence of a hydrogenation catalyst. Examples of suitable hydrogenation catalysts include supported catalysts such as palladium on carbon (Pd/C) (Pearlman's Catalyst), platinum on carbon (Pt/C), Raney nickel, Pd(OH)₂ on carbon, Pd on barium sulfate, Pd on calcium carbonate, poisoned with lead or sulfur (Lindlar's Catalyst), and the like. As shown in Example 3 below, it was observed that with higher catalyst loading (approximately 1:1) relative to mass of starting material), for example 1 unit mass per 1 unit mass of starting material, the reaction proceeded to reduce the carbon-carbon double bond in Formula (II) while at the same time effecting removal of the silyl groups to afford the compound of Formula (I). With lower catalyst loading, for example, roughly 25% of that used above, the carbon-carbon double bond was reduced, while the silyl groups remained intact. In this latter instance, the silyl groups were removed by treatment with aqueous acid and a C₁-C₆ alkanol, such as aqueous hydrogen chloride plus methanol, to afford the compound of Formula (I).

Thus, in a further aspect, the invention provides the above process, further comprising the step: (d) treatment with aqueous acid and a C₁-C₆ alkanol.

This invention can be further illustrated by the following examples of certain embodiments thereof, although it will be understood that these examples are included merely for purposes of illustration and are not intended to limit the scope of the invention unless otherwise specifically indicated.

### EXAMPLES

General: All experiments were carried out using dry glassware under an atmosphere of nitrogen unless otherwise noted. Reagents and solvents were purchased from commercial sources and used as received unless otherwise noted.

NMR Characterization: Proton NMR data were obtained on a Bruker Avance 500 NMR spectrometer operating at 500 MHz. The sample tube size was 5 mm, and samples were collected using either CDCl₃ or CD₃OD as the solvent. Chemical shifts are reported in parts per million (“ppm”) from tetramethylsilane with the residual solvent peak as internal reference.

### Example 1 1,4-Bis((trimethylsilyl)oxy)cyclohexa-1,3-diene

An oven-dried 100 mL round bottomed flask was allowed to cool under a continuous purge of N2. The flask was then charged with 1,4-cyclohexane-1,4-dione (1 g, 8.9 mmol, 1.00 equiv) and CH2Cl2 (30 mL) and subsequently fitted with a septum. 2,3,4,6,7,8,9,10-Octahydropyrimido[1,2-a]azepine (DBU) (CAS No. 6674-22-2) (6.79 g, 44.6 mmol, 5.00 equiv) was added in one portion, and trimethylsilylchloride (TMSCI) (3.88 g, 35.7 mmol, 4.00 equiv) was added dropwise, resulting in a mild exotherm. Once the addition of TMSCI was complete, the reaction mixture was warmed to 40° C. and stirred until ¹H NMR analysis showed complete conversion of the starting material, typically 2 hours. The reaction mixture was cooled to room temperature and concentrated on a rotary evaporator at room temperature. The resulting slurry was diluted with heptane (30 mL) resulting in a separation of phases. The top phase was decanted into a separatory funnel and washed with water (3×20 mL). The organic phase was subsequently dried with sodium sulfate and concentrated en vacuo to afford the crude diene (1.7 g, 74% yield). ¹H NMR analysis revealed a 9:1 mixture of 1,4-bis((trimethylsilyl)oxy)cyclohexa-1,3-diene and 1,4-bis((trimethylsilyl)oxy)cyclohexa-1,4-diene, respectively. Spectral data were in agreement with those previously reported.

¹H NMR (CDCl₃, 500 MHZ) δ 4.96 (s, 2H), 2.31 (s, 4H), 0.20 (s, 18H).

### Example 2 (1s,4s)-1,4-Bis((trimethylsilyl)oxy)bicyclo[2.2.2]oct-2-ene

A 100 mL autoclave was charged with 1,4-bis((trimethylsilyl)oxy)cyclohexa-1,3-diene (3 g, 11.70 mmol, 1.00 equiv) and p-xylene. The autoclave was sealed and purged three times under an atmosphere of nitrogen. The autoclave was pressurized to 500 psi with ethylene, agitation was set to 500 rpm, and the autoclave was heated to 250° C., resulting in an internal pressure of 4000 psi. This condition was held for 6 hours. Once this hold period was completed, agitation was stopped, and the autoclave was allowed to cool. The reaction mixture was subsequently transferred to a separatory funnel and washed with water (3×20 mL). The organic layer was dried with sodium sulfate and concentrated in vacuo to afford the crude product (2.2 g, 66% yield).

¹H NMR (CDCl₃, 500 MHZ) δ 6.04 (s, 2H), 1.74 (d, J=6.9 Hz, 4H), 1.53 (d, J=6.3, 4H), 0.15 (s, 18H).

### Example 3 Bicyclo[2.2.2]octane-1,4-diol (1)

### Process Option A

The crude (1s,4s)-1,4-bis((trimethylsilyl)oxy)bicyclo[2.2.2]oct-2-ene from Example 2 was taken up into 30mL of methanol in a Paar shaker vessel. 2.2 Grams of Pd/C were added to the vessel. The vessel was pressurized to 20 psi with an atmosphere of hydrogen, and the mixture was shaken for 6 hours. The reaction mixture was subsequently filtered through a pad of celite and concentrated. The crude product was isolated via trituration with CH₂Cl₂ and heptanes to afford the title compound in 51% yield.

### Process Option B

Alternatively, the crude (1s,4s)-1,4-bis((trimethylsilyl)oxy)bicyclo[2.2.2]oct-2-ene (8.39 grams) was subjected to the same hydrogenation conditions described above using 2.2 grams of Pd/C, and the mixture was shaken for 6 hours under 20 psig of hydrogen. After filtration and concentration, ¹H NMR analysis revealed complete reduction of the alkene but retention of the trimethylsilyl groups. The residue was taken up into 15 mL of methanol, and 15 mL of HCl_{(aq)} was added. After stirring 2 hours at room temperature, the mixture was transferred to a separatory funnel and extracted with CH₂Cl₂ (3×15 mL). The combined organics were dried with anhydrous sodium sulfate and concentrated in vacuo. The crude product (1.62 g, 39% yield) was obtained via the analogous trituration step described above.

¹H NMR (CD₃OD, 500 MHZ) δ 6.61 (s, 2H), 1.75 (s, 12H).

The invention has been described in detail with particular reference to preferred embodiments thereof, but it will be understood that variations and modifications can be effected within the spirit and scope of the invention.

1. A process for preparing compounds of the Formula (II): 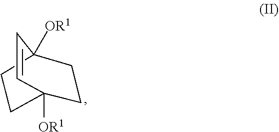
wherein R¹ is a group of the formula of the formula —Si(C₁-C₆ alkyl)₃, which comprises:
(a) contacting cyclohexane-1,4-dione with a non-nucleophilic base, in the presence of a compound of the formula (R²)₃Si—X, wherein X is chosen from chloro, bromo, or iodo, and R² is a C₁-C₆ alkyl group followed by
(b) reaction with ethylene at a temperature of about 200° to about 300° C. and a pressure of about 3000 to 5000psi,
Wherein the non-nucleophilic base is 2,3,4,6,7,8,9,10-octahydropyrimido[1m2-a]azepine.

2. The process of claim 1, wherein the compound of the formula (R²)₃Si—X is chosen from trimethylsilyl chloride, trimethylsilyl bromide, triethylsilyl chloride, and triethysilyl bromide.

3. A compound of Formula (II): 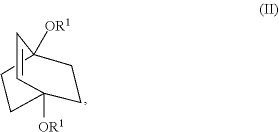
wherein R¹ is a group of the formula —Si(C₁-C₆ alkyl)₃.

4. The compound of claim 3, wherein R¹ is trimethylsilyl.

5. A process for preparing a compound of the Formula (I): 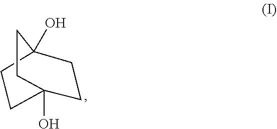
which comprises treatment of a compound of Formula (II) 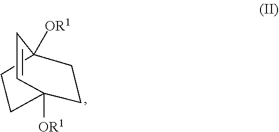
with hydrogen in the presence of a hydrogenation catalyst.

6. A process for preparing a compound of the Formula (I) 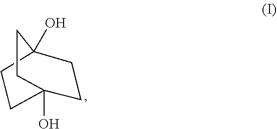
which comprises:
(a) contacting cyclohexane-1,4-dione with a non-nucleophilic base, in the presence of a compound of the formula (R²)₃Si—X, wherein X is chosen from chloro, bromo, or iodo, and R² is a C₁-C₆ alkyl group, followed by
(b) reaction with ethylene at a temperature of about 200° to about 300° C. and a pressure of about 3000 to 5000psi, to afford a compound of the Formula (II) 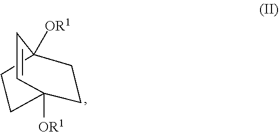
wherein R¹ is a group of the formula of the formula —Si(C₁-C₆ alkyl)₃, followed by
(c) treatment with hydrogen in the presence of a hydrogenation catalyst
Wherein the non-nucleophilic base is 2,3,4,6,7,8,9,10-octahydropyrimido[1,2-a]azepine.

7. The process of claim 6, further comprising the step:
(d) treatment with aqueous acid and a C₁-C₆ alkanol.

8. The process of claim 7, wherein the aqueous acid is aqueous hydrochloric acid and the C₁-C₆ alkanol is methanol.

9. The process of claim 6, wherein the compound of the formula (R²)₃Si—X is chosen from trimethylsilyl chloride, trimethylsilyl bromide, triethylsilyl chloride, and triethysilyl bromide.

10. The process of claims 6, wherein the hydrogenation catalyst is chosen from palladium on carbon (Pd/C); platinum on carbon (Pt/C); Raney nickel; Pd(OH)₂ on carbon; Pd on barium sulfate; and Pd on calcium carbonate, poisoned with lead or sulfur.

11. The process of claim 6, wherein the compound of the formula (R²)₃Si—X is trimethylsilyl chloride, the hydrogenation catalyst of Pd/C.

12. The process of claim 6, wherein R¹ is trimethylsilyl.
